(19) United States
(12) Patent Application Publication
(10) Pub. No.: US 2024/0019082 A1
(43) Pub. Date: Jan. 18, 2024

(54) METHOD FOR SUPPLYING CRYOGENIC FLUID TO A USER STATION, IN PARTICULAR A MACHINING STATION

(71) Applicant: L'Air Liquide, Société Anonyme pour l'Etude et l'Exploitation des Procédés Georges Claude, Paris (FR)

(72) Inventors: Alban POIRIER, Le Chesnay (FR); Etienne CHARVE, Vanves (FR); Fabrice BOUQUIN, Guyancourt (FR)

(21) Appl. No.: 18/030,379

(22) PCT Filed: Sep. 10, 2021
(86) PCT No.: PCT/EP2021/074971

§ 371 Date: Apr. 5, 2023

(30) Foreign Application Priority Data
Oct. 5, 2020 (FR) 2010131

(51) Int. Cl. F17C 7/02; F17C 13/02

(52) U.S. Cl. CPC F17C 7/02; F17C 13/02; F17C 2205/0332; F17C 2221/014; F17C 2223/013; F17C 2227/0107; F17C 2250/0443; F17C 2250/0626

(57) ABSTRACT

A method for supplying a user station for carrying out machining operations with a cryogenic fluid, having a liquid/gas two-phase fluid from a cryogenic fluid storage tank, the cryogenic fluid storage tank contains, under a storage pressure higher than atmospheric pressure, a cryogenic fluid in the liquid phase at the bottom of the tank and in a gaseous phase at the top of the tank, the tank being designed to supply the station with liquid phase withdrawn from the bottom of the cryogenic fluid storage tank. Wherein a gas/liquid phase separation means is provided, which is supplied with the liquid/gas two-phase fluid from the tank and carries out a separation of a substantially liquid phase and a substantially gaseous phase of the cryogenic fluid, the substantially liquid phase being directed toward the user station; wherein the gas/liquid phase separation means has a gas outlet.

### CROSS REFERENCE TO RELATED APPLICATIONS

This application is a 371 of International Application No. PCT/EP2021/074971, filed Sep. 10, 2021, which claims priority to French Patent Application No. 2010131, filed Oc. 5, 2020, the entire contents of which are incorporated herein by reference.

### BACKGROUND

The present invention relates generally to methods using a cryogenic liquid such as liquid nitrogen and in which the liquid/gas two-phase content arriving at the user station is an important factor, i.e. influencing the quality of this product or this station carries out, this being the case in particular in the field of the cryogenic machining of mechanical parts, this also being the case for example for food-grade cryogenic mixers equipped with nozzles for injecting through the bottom part of the mixers.

The case of machining will be discussed below.

Machining is a method for shaping workpieces by removing material. The mechanical energy required for machining, and therefore the formation of swarf, is almost completely converted into heat. Despite the good thermal conductivity properties of some machined and machining materials, the use of a cutting fluid remains compulsory in order to ensure:
cooling and lubrication of the cutting zone;
but also the removal of swarf from the work area.

These cutting fluids are predominantly neat or soluble mineral or synthetic based oils. The temperatures encountered at the heart of the cutting zone (currently +800° C. to +1000° C.) lead both to the production of fumes or gases that are harmful to the external environment, and to chemical pollution of the swarf and machined surfaces that can even impair their properties.

Oils are a major expense due to their purchase and recycling costs, but also their management. In this context, the lubrication methods referred to as “micro-lubrication” or “dry lubrication” reduce, or even eliminate, the consumption of cutting fluids. The machining performance is degraded thereby, and for this reason these methods are applied only in machining scenarios that require only little cooling of the cutting zone (such as machining aluminum based materials, high-speed machining, etc.).

In the other machining scenarios, namely those that require considerable cooling of the cutting zone, machining by adding cryogenic fluid, which will be referred to as “cryogenic machining” below, is a highly attractive solution for cooling and lubricating the cutting zone, combining the advantages of oils (swarf removal, heat transfer fluid, etc.) and those of dry machining (respect for the environment, non-pollution of the generated surfaces, swarf recycling, increased tool life, etc.).

This cryogenic fluid may be nitrogen and CO₂.

There is extensive prior art relating to the supplying of such machine tools with the aid of a cooling fluid (for the cutting tool, the cutting zone, etc.) and in particular with the aid of a liquid cryogen such as liquid nitrogen.

A cryogenic fluid is commonly understood to be fluid which, at atmospheric pressure, is liquid at a temperature far below 0° C.

Such a cryogenic liquid (for example liquid nitrogen) is traditionally supplied to a consumer equipment item, regardless of its type, from a cryogenic fluid tank connected to the consumer equipment item for this fluid, the tank containing, under a storage pressure higher than atmospheric pressure, a cryogenic fluid in the liquid phase at the bottom of the tank and in the gaseous phase at the top of the tank, this tank being designed both to supply the consumer equipment item with liquid withdrawn from the bottom of the tank and to be supplied with fluid from the outside.

Use is made most commonly in industry of so-called “low storage pressure” tanks, i.e. those in which the maximum pressure achieved at the top of the tank is generally lower than around 4 bar absolute, but, depending on the intended applications, so-called medium pressure storage tanks that achieve up to 15 bar, or even high pressure storage tanks that achieve up to 30 bar, are also found.

Since the storage pressure of the tank is higher than atmospheric pressure, the opening of a valve placed on the pipe connecting the tank to the consumer equipment item (for example a machine tool) causes the liquid to move from its drawing point to its point of use, without a forced drive means and in spite of the pressure losses on the line (valves, bent portions etc.).

In order to ensure that the driving of the cryogenic liquid is always effective regardless of the level of liquid in the tank, the pressure of the gas at the top of the tank is conventionally regulated such that this pressure remains substantially equal to a predetermined, fixed value, for example around 2 to 4 bar (more widely 2 to 15 bar).

However, the pressure of the liquid at the bottom of the tank varies depending on the height of the liquid inside the tank, such that, as the liquid level drops, the pressure of the liquid withdrawn drops and tends to approach the pressure of the gas at the top. For example, in the case of nitrogen, a liquid height of around 10 meters implies a pressure difference of around 0.7 bar between the gas pressure at the top and the liquid pressure at the bottom of the tank, at the drawing point.

This variation in pressure of the liquid at the drawing point necessarily leads to a variation in the flow rate of liquid withdrawn, bringing about disturbances in the operation of the consumer equipment item situated downstream. A symmetric effect occurs during the resupplying of the tank with fluid.

For well-known reasons of better “cryogenic quality” in terms of available cold energy, the literature and these industries that make use of cryogens, and in particular the machining industry, have become interested in means for supplying these user stations with pure or substantially pure liquid or with subcooled liquid, that is to say with liquid at a reduced pressure, and at a temperature lower than when it was at a higher pressure.

Specifically, considering the example of machining, the higher the spraying pressure in the machining zone, the better the coefficients of heat exchange. However, when the cryogen, for example liquid nitrogen, is sprayed, gas is created—on account of its expansion—at the spray nozzle. The quantity of gas generated is directly proportional to the temperature of the liquid nitrogen and its pressure upstream of the nozzle. The advantage of endeavoring to have a subcooled liquid will therefore be understood.

Among the large amount of literature that is available, it will be noted that certain studies have recommended the use of phase separation (degassing) means on the line connecting the tank to the consumer equipment item; reference could be made for example to the document EP-2 347 855.

Other solutions have proposed coupling two tanks and of using them alternately after filling and depressurization. The drawbacks of this solution are very clearly the very great handling that is brought about and the mobilization of two tanks.

Another solution is to insert a heat exchanger (for example a plate heat exchanger) just upstream of the point of use: the liquid nitrogen to be cooled (typically originally at 3 bar and a temperature of around −185° C.) circulates in one of the paths of the exchanger (main circuit), while a depressurized nitrogen, typically at a pressure of around 1 bar and a low temperature, around −196° C., circulates in another path of the exchanger. It is the exchange between these two paths, cocurrently or countercurrently, that will make it possible to subcool the nitrogen in the main circuit. However, controlling the temperature is difficult to manage and stabilize here, in particular when the consumer equipment item downstream operates discontinuously, obliging the exchanger to pass through phases of heating and recooling, etc.

Reference could also be made to the document WO2004/005791 in the name of the Applicant, which recommends varying the pressure of the gas at the top of the tank depending on the state of operation of this tank (consumption phase of the downstream user installation, standby phase, or phase of supplying the tank with cryogenic liquid), and which rightly recommends, according to one of its embodiments, venting the tank during the standby periods. In other words, when the tank is not subjected to withdrawal operations and will not be a priori for a significant period of time, for example several hours (for example overnight), a control unit orders the opening of a valve for venting the top part of the tank. The gas pressure at the top of the tank then passes from a storage value to a value substantially equal to atmospheric pressure (residual pressure of a few hundred grams). Thus, by lowering the storage pressure of the nitrogen in this way, the variation in enthalpy of the latter tends to increase, which amounts to having a fluid with a temperature much lower than when it was under pressure. The fluid thus stored during these periods of non-use of the tank therefore has a temperature lower than the usual, ensuring a better cryogenic quality in terms of available cold energy. In fact, a rapid repressurization—using for example its own atmospheric heater or the like—makes it possible to use the destabilized (subcooled) liquid.

Nevertheless, this solution is not without drawbacks, this venting necessarily involves losses, and furthermore the paradox of this procedure lies in the need for repressurization in order for it to be possible to use the nitrogen, and therefore to let in heat. Experimentation of this solution has in particular demonstrated a vaporization of 4 to 9% of the volume stored. Since this vaporization is not exploited, the cost has a direct impact on the user site.

In sum, two major drawbacks of this venting solution are inferred therefrom:
1) The use of nitrogen that is not able to be exploited for repressurization.
2) The inlet of a hot gas into the storage tank for depressurization and the creation of a thermal bridge.

Consideration has also been given to supplying the user station, for example a machining station, directly from a cryogen storage tank at medium or high pressure, but then the creation, at the outlet of the spray nozzle, of a large quantity of gas is observed, this gas reducing exchanges of heat.

Lastly, consideration may be given to supplying the machine from a low pressure storage tank and through a pump, but the difficulties associated with the handling of such pumps are known, and added to these is the impossibility of supplying several machining stations of a single site at different pressures and at a low flow rate.

### SUMMARY

The present invention endeavors to propose a technical solution for controlling and maintaining operating conditions at desired levels in an operation using cryogenic liquids, for example a machining operation, these conditions being associated with the characteristics of temperature, pressure, and two-phase content of the cryogen employed.

The case of machining will very particularly be discussed in the following for reasons of ease, but it will be appreciated that the considerations discussed above and below relate and are adapted more widely to numerous other applications that use cryogenic liquids.

In this regard, as will be shown in more detail in the following, the invention considers that the cryogenic machining (or similar) method does not necessarily require knowledge of the two-phase content in the liquid cryogen, for example in the liquid nitrogen, but rather requires monitoring thereof and the analysis of any deviations thereof over time, for example during each machining operation. And proposing the adoption of this new approach is the merit and characteristic of the present invention.

It is known that many studies have attempted and still attempt to develop a flow meter which makes it possible to measure a flow rate of liquid cryogen and to measure the two-phase content thereof. To date, the systems developed have not been satisfactory or have certain weaknesses (cost, size, precision, etc.), these weaknesses being prohibitive for the field of cryogenic machining.

Therefore, the present invention proposes not measuring the gas content in the cryogenic liquid but rather measuring the fluctuations in the two-phase content, with a simple and inexpensive system.

In this regard, the flow rate of gas at the gas outlet of a degassing pot (or other phase separator) is measured and the deviations in this gas flow rate over time are measured, these measurements, as it will be appreciated, being directly linked to the fluctuations in the two-phase content.

It is known that a degassing pot is characterized by a maximum flow rate depending on the pressure of the gas extracted with respect to the liquid and does not guarantee being 100% two-phase at the outlet of the degassing pot.

By way of illustration, in the case of one implementation example of cryogenic machining, the flow rates of liquid nitrogen are conventionally around 2 l/min, the maximum flow rate of gas of the degassing pot therefore makes it possible, at 10 bar, to “purge” around 250 l/min of nitrogen gas, and therefore enough to purge the gas part in any configuration.

The degassing pot will therefore not always be open in the injection mode.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 presents an example of an installation for implementing the invention, making it possible to understand the present technical proposal better.

FIG. 2 is a schematic representation showing typical variations in the flowrate of liquid to the user station.

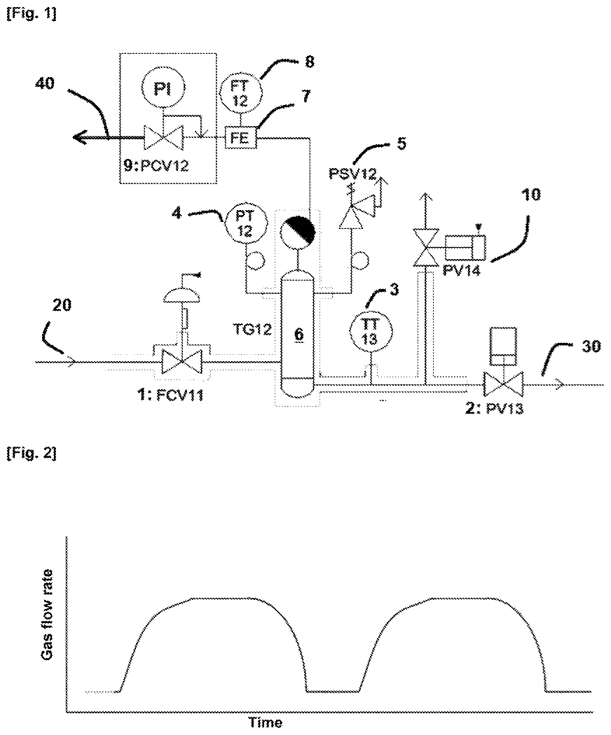

The nomenclature of the elements in the figure is as follows:
1: “FCV11”=valve for regulating the flow rate (under pressure)
2: “PV13”=liquid shut-off valve making it possible to open the bypass PV14 (degassing therefore takes place here and not in the downstream user process), this being a so-called “normally closed” valve.
3: “TT13”=temperature transmitter
4: “PT12”=pressure transmitter
5: “PSV12”=overpressure relief valve
6: “TG12”=phase separator, for example a degassing pot
7: “FE”=flow meter or flow rate sensor (able to supply a signal that is able to be used to control other elements of the installation)
8: “FT12”=flow meter or flow rate sensor (able to supply a signal that is able to be used to control other elements of the installation), able to supply a measurement of the gas flow rate (therefore of the two-phase flow)
9: “PCV12”=backpressure regulator, for ensuring a backpressure in the degassing pot and for promoting a more reliable measurement of the gas flow rate, this backpressure regulator representing an advantageous option according to the invention.
10: “PV14”=shut-off valve on bypass, this valve being a so-called “normally open” valve; this valve is a cooling valve, it is possible (and optional) to slave this valve to the observation of the change in the two-phase content.
20: the cryogen entering
30: the cryogenic liquid exiting and directed toward the user station
40: the gas outlet of the phase separator.

### DETAILED DESCRIPTION OF PREFERRED EMBODIMENTS

The measurement of the two-phase content by virtue of this installation, via the gas flow rate or sensor “FT12”, makes it possible to undertake for example one or more actions from the following actions:
informing the user station of the variations in the two-phase content of the fluid arriving at the machining station;
stopping the method via an action on the liquid shut-off valve PV13 if the user decides to;
adjusting the flow rate, increasing it if necessary, via the regulating valve FCV11, in order to keep the amount of cold energy constant (therefore an increase in the pressure with this type of valve);
repeating a degassing phase (and therefore recooling) in order to eliminate the two-phase excess via the valve PV14 on the bypass.

As will be clearly apparent to a person skilled in the art, the raw signal from the flow meter or flow rate sensor 8 is not usable as is since the operation of the separator/degassing pot via the float thereof makes the flow rate non-constant and characterized by jolts.

Therefore, post-processing of this signal by a controller is advantageously carried out:
during cooling of the line, the mass flow rate is not constant (hot liquid, unstable gas/liquid percentage, etc.).
in production mode of the user station, for example of the downstream machining station, the flow rate undergoes variations, of type as can be seen (schematically) in the appended [FIG. 2] corresponding to tool changes and the number of machines supplied by the same network (variable flow rate).

The post-processing carried out by the controller can thus take into account for example one or more of the following criteria:
the number of opening cycles/periods of the degassing pot over a production cycle, for example a machining cycle between two tool changes (information on the cycle start and end collected by the controller) over a single given duration.
the opening duration of the degassing pot each time the latter is opened: value of the opening duration, variation over time of this opening duration, which is constant or changing.
the integral of the gas flow rate measured during each machining cycle. The average of the two-phase content throughout the use of cryogenic fluid can be calculated.

The flow rate of liquid cryogen, for example of liquid nitrogen, will depend, as will be easily understood, on the program selected for the machining operation (and therefore for example on the pressure downstream of the inlet valve into the machining zone) and on the diameters of the injection orifices corresponding to the various machining phases (roughing, finishing, material, depth of pass, etc.), while, as it will be appreciated, the method according to the invention does not carry out and does not supply a measurement of the flow rate of liquid nitrogen.
the comparison of the above criteria between 2 production cycles and the output of an alert if variations are observed (under conditions in which the pressure conditions of liquid nitrogen at the inlet into the machining zone and of the injection orifice are identical for these 2 cycles)
the standby modes will be separated from the calculation by collecting the ongoing machining signal from the machine toward the controller etc.

The origins of a modification of the two-phase content during a machining operation may be considered to be the following:
blockage of the float of the degassing pot (the impact of this is very high)
when several equipment items draw from the same storage tank, the stoppage or one or more of these equipment items may have an impact on the other equipment item which, for its part, remains in operation
filling of the liquid nitrogen storage tank occurring while a machining operation is ongoing
a leak from a member of the liquid nitrogen fluid network.

The present invention thus relates to a method for supplying a user station with a cryogenic fluid such as liquid nitrogen, wherein the liquid/gas two-phase content arriving at the user station is a factor that influences the quality of the operation carried out by this station, from a cryogenic fluid storage tank, which tank contains, under a storage pressure higher than atmospheric pressure, the cryogenic fluid in the liquid phase at the bottom of the tank and in the gaseous phase at the top of the tank, said tank being designed to supply said station with liquid withdrawn from the bottom of the tank, and to be supplied with fluid from the outside, characterized in that:
i) a gas/liquid phase separation means, for example a degassing pot or a phase separator, is provided, which is supplied with cryogenic fluid from said tank and carries out the separation of a substantially liquid phase and a substantially gaseous phase of said cryogenic fluid, said substantially liquid phase being directed toward the user station;
j) the fluctuations in the liquid/gas two-phase content arriving at the user station are measured over time, for example during each operating phase of the user station:
   by having a measurement of the flow rate of gas output from the gas outlet of the phase separation means and by measuring any deviations in this flow rate of gas over time; or
   by having information supplied by a flow rate sensor situated at the gas outlet of the phase separation means, this information being of the 0/1 binary type, making it possible to detect the existence of a flow rate at the outlet of the separation means and to determine the opening time of the sensor over a given time interval;
k) depending on the result of the determinations made in j), one or more actions are undertaken in order to inform the user station and/or to modify the operating conditions of this user station.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-4. (canceled)

5. A method for supplying a user station for carrying out machining operations with a cryogenic fluid, comprising:
a liquid/gas two-phase fluid from a cryogenic fluid storage tank,
the cryogenic fluid storage tank contains, under a storage pressure higher than atmospheric pressure, a cryogenic fluid in the liquid phase at the bottom of the tank and in a gaseous phase at the top of the tank, said tank being designed to supply said station with liquid phase withdrawn from the bottom of the cryogenic fluid storage tank, and to be supplied with fluid from the outside, wherein:
a) a gas/liquid phase separation means is provided, which is supplied with the liquid/gas two-phase fluid from said tank and carries out a separation of a substantially liquid phase and a substantially gaseous phase of said cryogenic fluid, said substantially liquid phase being directed toward the user station; wherein the gas/liquid phase separation means has a gas outlet,
b) fluctuations in the liquid/gas two-phase fluid arriving at the user station are measured over time,
wherein a flow meter is provided, and the flow meter measures the flow rate of gas output from the gas outlet of the gas/liquid phase separation means, and measuring any deviations in the flow rate of gas output over time; or
wherein a flow rate sensor is provided, the flow rate sensor being situated at the gas outlet of the gas/liquid phase separation means, this information being of the 0/1 binary type, making it possible to detect the existence of a flow rate at the outlet of the separation means and to determine the opening time of the sensor over a given time interval,
k) depending on the result of the determinations made in b), one or more actions are undertaken in order to inform the user station and/or to modify the operating conditions of the user station.

6. The method as claimed in claim 5, wherein the signal supplied by the flow meter or the flow rate sensor is post-processed by a controller, this post-processing taking into account one or more of the following criteria:
the number of opening periods/cycles of the gas/liquid phase separation means over a production cycle of the user station for one and the same given duration,
the opening duration of the gas/liquid phase separation means each time the latter is opened, in order to take into account in particular the value of the opening duration, and/or the variation over time of this opening duration, which is constant or changes,
the integral of the gas flow rate measured during each production cycle of the user station.

7. The method as claimed in claim 1, wherein the user station carries out machining operations.

8. The method as claimed in claim 1, wherein the user station is a food-grade cryogenic mixer equipped with nozzles for injecting the cryogenic fluid through the bottom part of the mixer.
